(19) United States
(12) Patent Application Publication
(10) Pub. No.: US 2007/0158888 A1
(43) Pub. Date: Jul. 12, 2007

(54) Multi-storage isolator with tubular cross section

(75) Inventors: Daniel R. Domen, Rochester Hills, MI (US); Peter Jing-Lug Chen, Rochester, MI (US); Mohammed Ansari, Rochester Hills, MI (US)

Correspondence Address: Valeo, Inc.;Intellectual Property Department, 4100 North Atlantic Boulevard, Auburn Hills, MI, 48326, US

(73) Assignee: Valeo, Inc., Auburn Hills, MI (US)

(21) Appl. No.: 11/604,527

(22) Filed: Nov. 27, 2006

Related U.S. Application Data
(60) Provisional application No. 60/740,784, filed on Nov. 30, 2005.

(51) Int. Cl. F16M 1/00

(52) U.S. Cl. 267/136

(57) ABSTRACT

Isolator assemblies and isolators between separate parts or components, and, particularly, multi stage isolators, especially, isolators useful in automotive applications are described. The isolators have a tubular cross section, made of the same material as the isolator body, which can flex when in a deflection stage, or can compress in a compression stage, thus allowing for reduced wear and/or longer life for both the isolator and the parts and components separated thereby.

### FIELD OF THE INVENTION

The present invention relates to isolators, and, in particular, isolators useful in automotive applications, to reduce undesirable contact or impact, and/or its associated noise, between various parts or components of the automotive vehicle.

### BACKGROUND OF THE INVENTION

Isolators are useful in a number of applications, especially where vibration or other movement might occur between two devices, parts or portions of devices or parts. Such vibration or movement can cause both contact issues as well as noise issues related to undesired contact or impact Particularly in assemblies where devices or parts must be mounted together or in close proximity to one another, undesirable contact may occur, and isolators have, as one of their functions, the function of preventing or modulating undesirable contact in such a manner that it is either becomes a non-harmful contact, or even an advantageous one.

Isolation can occur in numerous stages or steps. Multi-stage isolation can be achieved in the same isolator or isolator pad by over-molding different density materials or by thinning specific webs called ‘thinning webs’ between mounting surfaces.

Isolators can be made from elastic material, and, thus, can have levels of stiffness. An isolator, for example, may be of a single stiffness. Isolators may also be made via various processes. An isolator, for example, may be made from a single molded process.

Isolators have been found to be particularly useful in automotive applications. One such application is that of heat exchanger assembles, particularly where such assemblies are mounted to vehicles, and, in particular, automotive vehicles. In such automotive applications, heat exchanger assemblies are often mounted either as a single unit or as a group in, for example, parts or components of a cooling module assembly.

In general automotive applications, vibration and other movements are felt throughout various areas of the automobile, particularly when the automobile is moving in the lateral or vertical sense. Otherwise stated, a motor vehicle, when either moving forward or backward, or when being transported in numerous directions, or even when idling with the motor operation, is subject to movement that may cause various parts or features of the automobile to contact one another. A heat exchanger assembly, and/or its component/parts, may contact or collide with other parts, components or portions of other assemblies or the frame of the automobile, and lead to potential damage to either the heat exchanger, the heat exchanger assembly, or other parts of the vehicle itself. This can be particularly disturbing due to the current trend of reducing the amount of materials and the type of materials used in component parts both of the automobile itself and the heat exchanger in particular. In the case of heat exchangers, for example, materials can account for more than half of the total cost of the exchanger. Such exchangers are, therefore, being made of materials that are of the minimal thickness possible—however, such thin metal and plastic materials often cannot withstand the impact stress which occurs through a motorized vehicle frame that occurs while driving on rough roads or making sudden stops or sharp turns. Isolators, correctly designed, reduce potential damage to the heat exchanger assembly under impact or contact stress conditions.

In any system where movement may cause undesired impact or contact between parts or devices, three elements are often considered. For example, in heat exchanger mounting and isolation systems, vibration issues, such as Noise, Vibration & Harshness (NVH), occur. This movement can be described as “low excursion/high frequency” vibration that produces “airborne sound” This movement can be described as medium inertia/medium frequency vibration. If the mounting has a relatively stiff vehicle component, it can receive and transmit vibrations that can annoy the quiet and comfort of the passengers in and around the vehicle. This movement can be described as ‘high inertia/low frequency impact’ often associated with “rough road” driving conditions. For example, severe differences could occur under conditions such as driving across a shallow hole or sharp turning of a vehicle at sufficient speed to cause damage to the heat exchanger assemblies. In such systems, one of the isolator's purposes is to allow for an attachment that is not too rigid, or even what might be called a ‘loose’ attachment of a heat exchanger assembly to a vehicle mounting frame. An isolator can also assist in dampening the differential movement between the heat exchangers and the vehicle, and thereby, help avoid undesired impact or contact between the heat exchanger assembly and the rest of the vehicle and/or its mounting or mounting frame.

Solutions to noise and vibration issues in various applications exist in the prior art. For example, soft isolators composed of lower durometer material (e.g. less than 30 durometer materials) have been used to eliminate noise transmission. The present the problem, however, that they can fail over time and are more often than not, unable to absorb high impact energy such as that experienced while driving an automotive vehicle on unpaved or otherwise rough roads. Other solutions to noise issues, such as the use of vertical standing ribs, are described U.S. Pat. No. 5,960,673, issued Oct. 5, 1999, to Eaton et al.,that can absorb initial noise transmission. However, this solution also has the disadvantage that the individual ribs can wear away prematurely because the high energy present is not adequately distributed over the full area of the isolator surface.

Stiff isolators, such as those described in U.S. Pat. No. 6,540,216 B2, issued Apr. 1, 2003, to Tousi et al., U.S. Pat. No. 4,858,866, issued Aug. 22, 1989, to Werner, can absorb impact shock between components by keeping the components separated, but, both noise and vibration are more easily transmitted through the stiff rubber members. Webbed isolators, such as those described in U.S. Pat. No. 6,722,641, issued Apr. 20, 2004, to Yamada et al., are described as having various thicknesses of rubber webs and/or plastic or metal insert members, and rigidly support the mount in or on each side of the isolator mounting face. The isolator uses a different thickness of rubber web to vary its stiffness. With this solution, when parts move closer together relative to each other, resistance increases. However, this sort of assembly also generally costs more than other isolators or isolator systems.

Loosely fitting isolators with, for example, an air gap at the mounting face, are show in U.S. Pat. No. 6,540,216 B2 issued on Apr. 1, 2003 to Tousi et al., wherein such isolators can be seen as useful in absorbing some misalignment of parts and/or undesirable vibration. However, such a gap can cause damaging impact from unrestricted acceleration across the gap when used between a heat exchanger and some adjacent components.

Dual density isolators, having two different density materials exist. Dual stage webbed isolators, for example, those using metal or plastic inserts, would normally require separate placement of the inserts and lead to increased piece cost and mold cycle time. Webbed isolators themselves can be too stiff and transmit too much vibration to be useful in many automotive applications. For example, when the isolator is softened to reduce vibration transmission, the isolators can fail prematurely, especially when the isolators have a thinned area of a web which can be stretched or compressed beyond their normal elastic limits (usually during harsh movements with high acceleration).

A single stage isolator can either solve one of the three problems described above, or be compromised to partially solve two of the problems, but cannot solve, in one unit, the above limitations. Likewise, a dual stage isolator, with different densities, requires a more expensive material process having two different density materials injected into the injection mold.

Most of the current technologies which have isolators that can absorb noise vibration and harshness has either or both reduced endurance or increased manufacturing costs. Low durometer (stiffness) isolator material can not be used to achieve high durometer (stiffness) requirement. Low durometer (stiffness) isolator material wear much quicker than high durometer (stiffness) isolator material. Wear can lead to uneven isolator compression and these designs will wear quickly.

The advantage of aspects of the present invention that he provide for isolator designs that are less expensive than traditional isolators and they absorb high frequency noise vibration, medium vibration and low frequency high inertia harsh vibration, without exhorbitant increase in production cost or sacrificing overall endurance of the isolator while various aspects of the present invention provide for use of higher durometer (stiffness) isolator to achieve low durometer and high duromater isolator requirements.

Isolators of various types are illustrated by two provisional applications filed Nov. 30, 2005, U.S. patent application Ser. Nos. 60/740,767 and 60/740,983, Daniel Domen, Peter Chen and Mohammed Ansari, which are hereby incorporated by reference in their entireties.

### SUMMARY OF THE INVENTION

The present invention relates, in various aspects, to isolator assemblies and isolators between separate parts or components, and, particularly, multi stage isolators, especially isolators useful in automotive applications.

The present invention, in its various aspects, avoids the problems of the prior art, especially due related to undesired contact or impact scenarios found in assembly of parts in automotive applications. In various aspects of the present invention, airborne noise, generated by contact or acoustic harmonic oscillations and/or movement, impact, is greatly reduced. By initially softly holding parts or components apart by an isolator, the movement of the oscillating component is slowed, in various aspects of the present invention, by an isolator having a tubular section—the initial “soft contact” is made to slow the resonant movement and alter movement towards a non-acoustic resonant frequency. In various aspects of the present invention, the isolator has at least two portions, with at least one portion having walls with an internal space or hollow portion. The hollow portion flexes as a wall or part of wall bend to flat. The wall or part of wall in the area of the hollow of the hollow portion collapses into the hollow, and the wall or part of wall previously in the hollow area is folded over or displaced near the rest of the isolator wall so that the folded over or displaced walls or parts of wall, together form an approximate equal to the thickness of the rest of the wall outside of the hollow.

In the automotive industry, heat exchange modules such as cooling modules, (modules assembled with the intention of using for heat transfer applications), may be assembled to or fixed to the automotive vehicle body, and, often, to the vehicle frame. The cooling modules should be assembled to the vehicle frame on a consistent basis, to have as closely as possible, a ‘perfect’ alignment. Each heat exchanger component or part of the module, has a fit with its adjacent or corresponding non-heat exchanger component or part, for example, need to be adjusted based on the varies relative positioning in space in the vehicle of the component or part. The fit can loose in many cases, or the components themselves can be grounded or snugly fit to each other through an isolator. Grounding transmits the vibration energy more or less in a direct manner to other components in the vehicle. Loose fitting assemblies can accelerate transfer of inappropriate energy, and, in particular, movement and later noise energy, during harsh driving conditions. Higher energy levels can damage both not only the cooling module, but also any adjacent components to either the module or the other parts of the automobile, or to the isolators between the cooling module, for example, and the adjacent components of the automobile.

The multi-stage isolator, of various aspects of the present invention, can be used in almost any vehicle or mobile system that requires noise isolation, component suspension to reduce transmitted vibration or more severe harshness conditions, for example as a vehicle or mobile system multi-portion isolator. For example, a mounting frame or a mounting frame vehicle component, an engine drive train component, a heat exchanger drive train component, or other components of an automobile vehicle, which are adjacent to one another, or otherwise contact one another, can be separated by use of isolators, in accordance with an aspect of the present invention.

Aspects of the present invention include use of isolator and component assemblies for use, for example, for suspension during shipment of more fragile assemblies packaged in larger container frames, such as assemblies in box containers used for train, plane or boat shipments.

The present invention, in various aspects, provides for an isolator that is made from a single durometer elastic material compound that can absorb lighter vibrations and also resist heavier impact load. In various embodiments of the present invention, the isolator is made of an elastic or elastomeric or rubber or rubber like material made of a single stiffness, and, therefore, in various embodiments from a single process.

In aspects of the present invention, a single higher durometer (stiffness) is used to provide adequate isolation at different level of load. A multi stage isolator is provided having a hollow area design within the isolator. Since higher durometer isolator material can resist wear, a simple and structurally stable design is possible. In various embodiments of the present invention, by providing for an isolator with a collapsable hollow area or “hollow”, after the hollow area collapses, the isolator is evenly compressed and will wear evenly.

Various aspects of the present invention provide for use of higher durometer (stiffness) isolator material to achieve low durometer and high durometer isolator requirements. Instead of using different materials, low stiffness requirement can be achieved by varying the size, the oval shapes of the hollow area.

The present invention, in its various aspects, allows for the production of “low cost” isolators that can be made from single durometer material. The present invention, under conditions of load, provides for an isolator that can flex under light load and/or flatten, and, in aspects of the invention, flatten to a uniform thickness, under heavier loading. The present invention, in various aspects, therefore, provides for an isolator of a single durometer material, and, in various embodiments, an elastic or elastomeric or rubber or rubber like material, that can go through at least two load resisting stages, depending on the loading due to contact (initial or light contact or impact ‘low inertia’), or later heavy contact or impact (‘heavy inertia’) that the isolator and part or component endure.

In various embodiments of the present invention, an isolator having two or more portions is provided, the number of portion based on desired isolation function. For example, when an isolator, in accordance with an aspect of the present invention, is subjected to load of varying intensity, it, adjusts to each load depending on intensity, in a different manner. For example, the different physical design characteristics of each portion of the isolator respond to produce a different effect (for example one portion of an isolator can flex (flexing portion) while another portion compresses (compressing portion) under load). The isolator, in aspects of the present invention, may also have one or more slit(s) that divide the walls of the first stage flexing portion to further enhance the initial flexibility of the first (flexion or ‘deflection’) stage and to ‘soften’ the initial deflection. The multiple stages of dampening of the isolator is provided by forming geometric shapes with hollow areas that can flex or deflect initially, and, thereafter be deflected, to flat and compressed in a second compression stage.

In various embodiments of the present invention, the isolator comprises at least two portions, a flexing portion (first portion) and a compression portion (second portion). The walls around the hollow areas in the first portion can be described as having a deflecting stage where the elastic material wall around the geometric hollow areas bends inward to fill in the space or area (‘hollow’) thereby allowing for suspension, for example, of a heat exchanger component relative a mounting frame in a motorized vehicle and, eventual absorption of vibration generated differential movement between the heat exchanger assembly and the mounting frame. In various aspects of the present invention, a multiple stage isolator is provided wherein deflected walls fill in or ‘close’ the space or area (‘hollow’) to form a uniform thickness wall with the remainder of the isolator to evenly distribute the harsh load energies over the area of contact of the wall sections.

Aspects of the present invention have an isolator, made of a uniform density material, having hollow portions shaped in an approximately tubular cross section. The connecting wall portions surrounding the hollow portions are of a thickness of approximately one-half (½) times the thickness of the remaining connecting wall portions thickness, such that, for example, if a tubular wall portion is deflected until it is more or less flat or reduced in overall area to flat, it doubles in thickness so that the overall thickness, in spite of the light load now applied to the isolator, is approximately equal to the ‘normal’ wall non-deflected thickness. The isolator wall, in the end of a first deflection stage, can have further load applied which leads to a second compression or compressing stage, where the uniform ‘doubled’ first portion wall works in unison with the full thickness wall second portion wall of the isolator to provide for an approximately even distribution of high inertia impact load. The approximately uniform full wall thickness not only improves the ability to absorb during high loading, it also improves the life of the isolator itself.

In various embodiments of the present invention the rate of allowed movement inward between the opposing component surfaces, relative to rate of increased load, is increased dramatically between the collapsing portion of the hollow section and the fully flattened constant thickness of the isolator. This rate change dampens the frequency/short excursion noise and vibration that normally would occur during the first deflection portion of movement.

The geometrical shape of the cross section around the hollow has an effect on the deflection rate. For example, as the base of the hollow wall at the connecting normal wall end approaches normal to vertical adjacent to the contact surface, the resistance increases as loads increase from light to heavier; the load requirement increases in order to deflect the wall a given distance toward the flat position.

In aspects of the present invention having at least one deflecting portion and at least one compression portion, the compression portion of the isolator provides for a low frequency/high inertia dampening during harsh conditions. In aspects of the present invention, having an isolator with an approximate tubular cross section, with an approximate wall thickness of one-half (½) times the normal constant wall thickness as when entering the compressive mode, the wall portion is of a constant thickness and is non-perpendicular to the contacting surface. In more particular aspects of the present invention involving an assembly of parts or components and at least one isolator for example, the isolator with tubular wall cross section has a wall that is generally not parallel to the contact surfaces of the opposing parts or components, e.g. a heat exchanger assembly and the mounting frame, and is generally not normal to the direction of inertia load being applied by the opposing parts.

In aspects of the present invention, the generally tubular shaped cross section area of the isolator provides a lower rate resistance to absorb noise and vibration transmission from, for example, in a heat exchanger assembly to a mounting frame in a motorized vehicle. The area at each end of the non-perpendicular wall is parallel to the contact area and connected to the normal wall such an “eyelet” shaped hollow between the outer wall. In particular aspects of the present invention, the thickness of the contact area is approximately the same as the wall thickness of the normal wall section.

As stated herein, the total effect of the use of isolators, in accordance with the present invention, depends on the distance between the parts or components isolated from each other. As the deflecting portion wall under load and collapses into or to partially ‘close’ the hollow, the distance between the two parts decreases, and the decreasing isolator cross section collapse the hollow so that the isolator leaves the range of noise and vibration and goes into the high energy impact and low compression movement condition.

In various aspects of the present invention, the isolator is made of a single material of a single (durometer) stiffness, and formed in a geometric shape that allows for deflection of a constant wall thickness at a first rate (first or deflection stage) (first load deflection rate) and compression of the final wall thickness at a second load/deflection rate or compression stage. The isolator or specifically the hollow portion of the isolator in the first stage, is flexed or deflected into an approximately flat configuration, and the overall wall thicknesses of hollow area, under increased load, to form the approximate thickness of the normal wall thickness for the compression stage. As load continues to increase, a second rate of higher load versus deflection occurs in the second or compression stage, with a uniform compression of the elastic material of the second isolator flattened hollow portion. The geometric shape change of the portions of the isolator provide for two separate load stages to meet the different misalignment, noise, and vibration and harshness conditions the components or parts are subject to. In various embodiments, the wall configurations distribute the load to an increased contact area at high inertia harshness conditions. In various embodiments, the geometric shapes are such that upon collapse, the walls ‘nest’ to form a uniform wall that minimizes the local stress on the thin wall areas to increase durability.

In various embodiments, the wall or walls of around at least one of hollow portions of the isolator have a slit or slits to separate sections of the walls to reduce overall tension in the isolator wall.

In a further embodiment of the present invention, the isolator, in addition to being tubular, can have a rib, or wiper rib or ribs, to allow for deflection characteristics related to lighter loads. For example, external wiper ribs may be used for soft positioning and noise absorption. In certain embodiments, the ribs are, in various embodiments, a positioned at angles of less than 90°to the contact surface tangencies so that they tend to deflect rather than compress. Also various embodiments are isolators with nesting pockets to receive the deflecting ribs to allow them to deflect flat with the normal contact surfaces to provide a uniform thickness at the surface of the isolator and the ribs fill the collapsing pocket for better distribution of heavier inertia loads.

### BRIEF DESCRIPTION OF THE DRAWINGS

FIG. 1 illustrates a heat exchanger isolators in mounting assembly, in accordance with an aspect of the present invention, showing slotted plate and pin mount type.

FIG. 2 illustrates a square tubular isolator with dual stage compression attributes, slotted plate mounting type, in accordance with an aspect of the present invention.

FIG. 3 illustrates a prior art single stage round pin isolator and donut shaped slotted plate isolator.

FIG. 4 illustrates a round tubular radial port pin isolator with wedge cut-out section, in accordance with an aspect of the present invention.

FIG. 5 illustrates a cross diameter tubular port round pin isolator with wiper ribs in pin hole, in accordance with an aspect of the present invention.

FIG. 6 illustrates a prior art solid rectangular block elastic isolator section.

FIG. 7 illustrates a hollow polygonal port and nested wall elastic isolator section, in accordance with an aspect of the present invention.

FIG. 8 illustrates a hollow elliptical port elastic isolator section, in accordance with an aspect of the present invention.

FIG. 9 illustrates a hollow eyelet and slit port elastic isolator section, in accordance with an aspect of the present invention.

FIG. 10 illustrates a hollow round port elastic isolator section, in accordance with an aspect of the present invention.

### DETAILED DESCRIPTION OF THE PREFERRED EMBODIMENTS

In embodiments of the present invention, an isolator is made of an elastic or elastomeric material, or rubber or rubber like material. In various aspects, the isolator is formed or molded, as a single durometer stiffness material.

The isolator is formed in such a shape that allows a hollow portion between the contact surfaces of the isolator and between the contact surfaces of the heat exchanger and the opposing mounting frame such as shown in Figures. The hollow portion adjacent walls are of a thickness such that when they are deflected to a flat position approximately parallel to the contact surfaces of the heat exchanger and mounting frame walls, they form an approximately uniform thickness with the remainder of the isolator wall portions so that the entire flattened isolator can demonstrate an approximate uniform load. The isolator walls, in various embodiments, accept, at the area of the hollow portions, an initial inertia loading during higher frequency lighter load inertias. Fully deflected hollow area walls, along with the remainder of the isolator wall portions, have an approximate uniform thickness wall which accepts lower frequency higher inertia loads, for example, and distributes them with approximate uniformity through the isolator between an opposing heat exchanger assembly and mounting frame at their contact areas. A mounting frame can be described as a vehicle frame component, and engine drive train component, or another heat exchanger assembly component.

An isolator, in various aspects of the present invention, has a tubular shaped hollow wall portion that has a wall surrounding the hollow portion having a wall thickness of approximately 0.5 times (½) the normal flat wall thickness such that when the isolator tubular wall section is deflected to the flat position, the double wall forms with the normal wall thickness to be of an approximate uniform thickness.

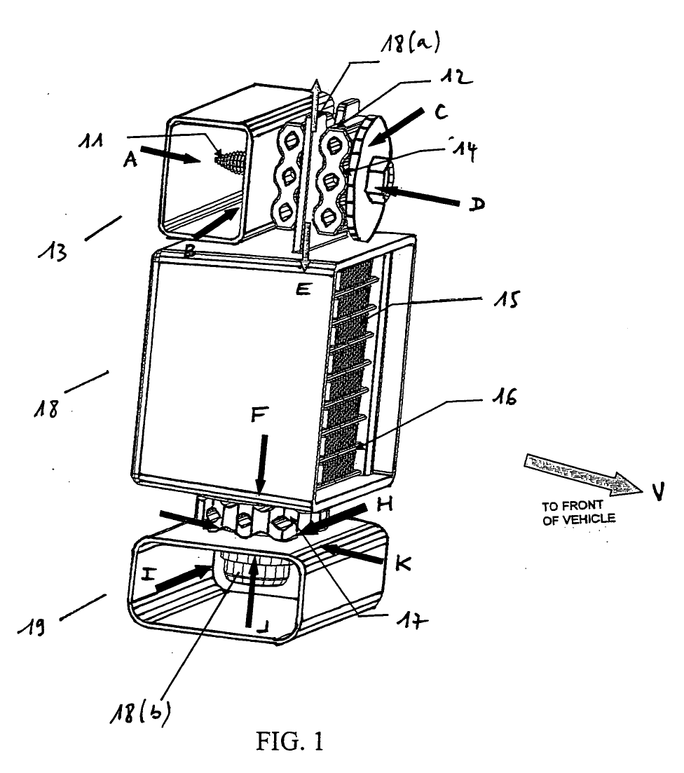

In aspects of the present invention, an isolator is provided to maintain position space between a component heat exchanger and the adjacent mounting frame. The isolator is formed in such a shape that allows a hollow portion between the contact surfaces of the isolator and/or between the contact surfaces of the heat exchanger and the opposing mounting frame such as shown in FIGS. 1, 2, 4, 5, 7, 8, 9 and 10. The isolator walls adjacent to the hollow portion are of a thickness such that, when deflected to a flat position approximately parallel to the contact surfaces of the heat exchanger and mounting frame walls, form an approximately uniform thickness with the remainder of the isolator connecting wall portions so that the entire flattened isolator can demonstrate an approximate uniform load.

A rib, and, in particular, a wiper rib, of the approximate same durometer may be present.

Various embodiments with a rib or ribs utilize a non perpendicular rib or ribs that deflect and nest into a hollow cavity in the isolator. The size of such ribs can vary, as they should be able to be received in the volume of hollow when deflecting as shown in FIG. 1.

In aspects of the present invention, having isolators, the ribs are spaced around the perimeter of the contact area to softly position one component or part (such as the heat exchanger) relative to a second component or part (such as a mounting frame of a vehicle) with contacting surfaces. Ribs, and, in various embodiments, so called wiper ribs, absorb noise vibration by maintaining separation of the heat exchanger isolator contact surface or opposing mounting frame contact surface off of the normal wall thickness of the isolator. By adding nesting ribs along the length of the tubular section outer wall of the isolator, in accordance with an aspect of the present invention, a 3^{rd} stage so called “light” load resistance occurs that precede deflection of the tubular wall.

In FIG. 1, vehicle mounting screw (11) is shown connecting round conical isolator (12) to housing (13). Anti-compression sleeve (14) limits over compressor of isolator (12) from screw (11). Load forces A during vehicle accelerator, for example), B (lateral during load on turns, for example) C and D (formal load during vehicle stopping, for example) are shown, with downward jounce and gravity movement E, not restricted along the isolator slot. Downward jounce and gravity movement, for example, restricted along lower isolator pin F, is shown.

Housing mounting for a heat exchanger or fan shroud (15), in form of an housing slot and lower housing pin mountings, is shown. Vehicle lower mounting member (16), shows restricted vehicle lateral mount along pin, for example, during sharp right turn of the vehicle. Round pin tubular isolator (17) is illustrated between pin portion of housing (18) and hole in vehicle frame (19), with housing forward stopping movement G restricted also isolator pin, vehicle lateral L movement restricted along pin during sharp left turns, for example, upward rebound movement Y not restricted along lower isolator pin and loads H and K (vehicle resisting load during stopping) illustrated). Arrow V represents the direction to front of the vehicle.

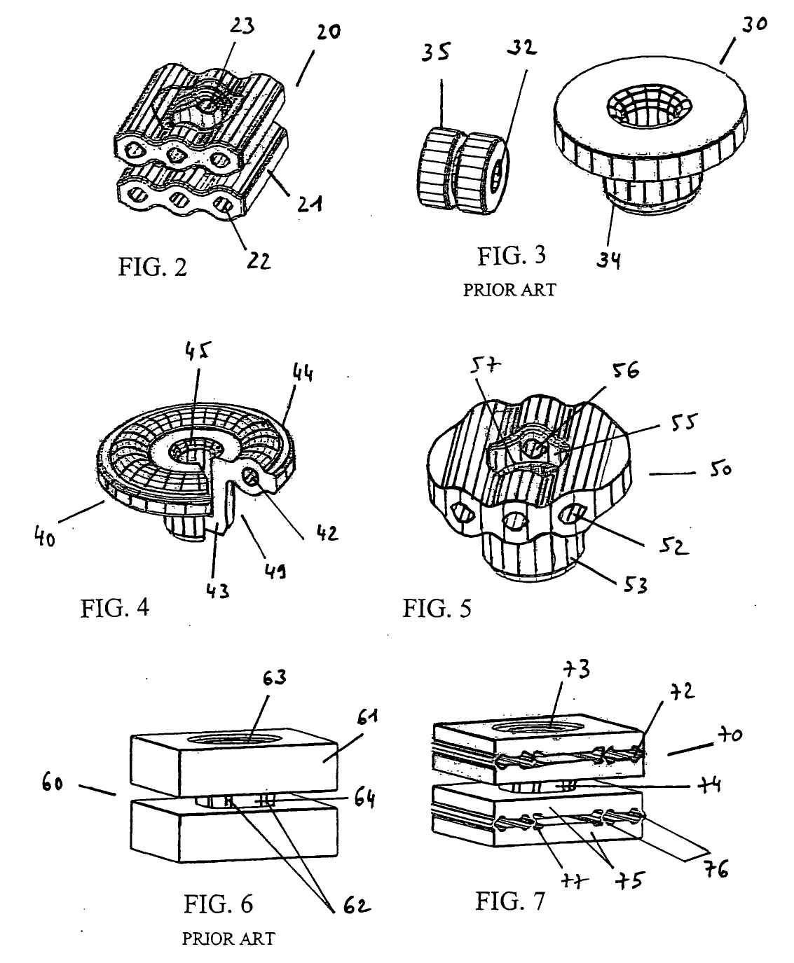

FIG. 2 shows square tubular slotted plate type isolator (20), with tubular portions (21), having hollow ports (22), and center hole (23), having dual stage compression attributes.

FIG. 3 shows prior art round solid pin isolator (30) and a slotted plate type (35), with a mounting center hole (32) and the pin type having a second cylindrical portion (34).

FIG. 4 illustrates a round tubular radial port pin isolator (40) with wedge cut-out section (49) showing radial tubular portion (42), cylindrical pin portion (43) and outer flat section (44), and center hole area (45) to receive a pin mount.

FIG. 5 illustrates a round tubular cross pin port pin isolator (50) with wiper ribs (57) in pin hole (55). Also illustrated is cross diameter tubular ports (52), and a cylindrical portion (53) to isolate pin and a rib portion (57).

FIG. 6 illustrates prior art solid rectangular pin isolator having double side solid pads (61), ribs (62) and center hole (63).

FIG. 7 illustrates a hollow tubular nested wall elastic section isolator (70) having a center hole (73),polygonal shaped hollow port (72), center cylindrical portion (74), and double wall flat portion (75) adjoined by hollow port webs (76) with nesting pockets (77).

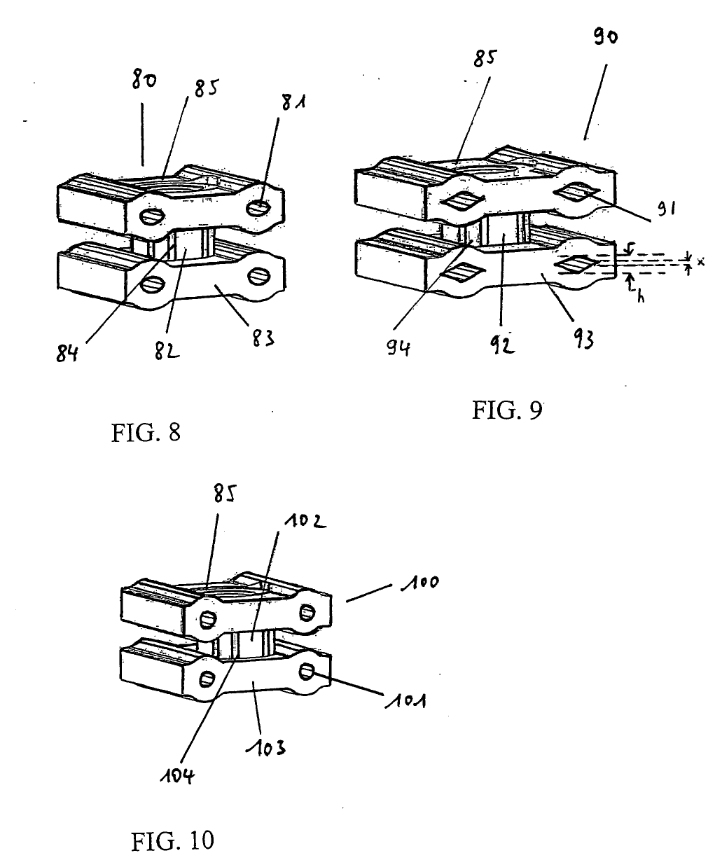

FIGS. 8-10 show hollow tubular elastic isolators (80, 90, 100), having tubular ports such as elliptical port (81), and slit port (91) and round port (101) and each isolator having a cylindrical section (102, 92, 83) and each having a flat portion (103, 93, 83), such that when the tubular portion walls are deflected to flat, the doubled walls approximately equal the thickness of the flat portion and a rib portion (84, 94, 104) and an open base portion (85, 95, 105). FIG. 9 shows height (h) of hollow portion and height (x) of the slit end portion.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The various embodiments of the present invention has been disclosed. A person of ordinary skill in the art would realize however, that certain modifications would come within the teachings of this invention. Therefore, the following claims should be studied to determine the true scope and content of the invention.

What is claimed is:

1. An isolator of a generally uniform stiffness for use between parts or components wherein the isolator is made of a single durometer material and has a tubular shaped cross section.

2. An isolator as in claim 1, wherein the isolator comprises at least two portions.

3. An isolator, as in claim 2, wherein at least one portion is a compression portion and wherein at least one portion is a deflection portion.

4. An isolator as in claim 3, further comprising at least one hollow portion.

5. An isolator as in claim 4, wherein the deflection portion is at least partially deflected into the at least one hollow at low inertial load conditions.

6. An isolator as in claim 5, further comprising at least one non-perpendicular rib.

7. An isolator as in claim 6, wherein the at least one rib, in compression, nests completely in the hollow.

8. An isolator, as in claim 7, wherein there are at least two ribs.

9. An isolator as in claim 5, wherein the isolator wall surrounding the at least one hollow wall forms an approximate tubular shaped cross section of approximate uniform thickness.

10. An isolator as in claim 9, wherein the tubular shaped cross section has an open base portion.

11. An isolator as in claim 5, wherein the isolator walls around the hollow of the at least on hollow portion, have at least one slit or aperture that divides the walls around the hollow area into symmetrical sections.

12. An isolator as in claim 6, wherein the isolator walls have an internal nesting cavity and, wherein at least one of the external walls of the isolator receives contact from adjacent component contact areas such that the at least one wiper rib that is non-perpendicular to the tangent contact surfaces that is deflected, upon load, into the nesting cavity.

13. An isolator as in claim 12, wherein that approximate the wiper rib volume, is such that it completely enters the nesting cavity to form an approximate uniform contact surface.

14. An isolator as in claim 13, such that the wiper rib deflects inward toward the normal isolator surface to form an approximate uniform contact surface.

15. An isolator as in claim 4, wherein the flat wall portions around the hollow are deflected upon load to displace the hollow portion between opposing contact surfaces until the wall thickness becomes an approximate uniform wall thickness.

16. An isolator as in claim 5, wherein the walls around the hollow area have at least one slit aperture to divide the walls around the hollow area into symmetrical sections.

17. An isolator and heat exchanger assembly, having an isolator as in claim 9, wherein at least one first part or component is a heat exchanger or portion of a heat exchanger and at least one second part or component is a part or component of, or a portion of a part or component of, a motor vehicle.

18. An isolator and heat exchanger assembly, as in claim 17, wherein the at least one second part is a mounting frame or portion of a mounting frame of an automotive vehicle.

19. An isolator and component assembly comprising:
a. an isolator having at least one wall which is tubular in shape when seen in cross section;
b. at least one hollow within at least part of the at least one wall;
c. a first component having a component contact surface facing an isolator wall;
d. a second component having a component contact surface facing an isolator wall;
wherein the isolator is made of a single durometer material of generally uniform stiffness, the isolator is located between the first and second components and wherein the isolator has at least one wall in alignment with its respective component contact surface.

20. An isolator and component assembly, as in claim 19, wherein the tubular shaped cross section has at least one slit.

21. An isolator and component assembly, as in claim 20, wherein the wall has at least one rib.

22. An isolator and component assembly, as in claim 21, wherein the isolator wall in alignment with it respective component contact surface, has least one rib.

23. An isolator and component assembly, as in claim 22, and wherein the at least one rib is a wiper rib, and wherein the wiper rib is non-perpendicular to a tangent drawn at the point of contact of the component contact surface and the isolator wall.

24. A heat exchanger assembly comprising:
a heat exchanger;
an isolator and component assembly; and
at least one isolator mount,
wherein the isolator and component assembly comprises at least one isolator having a tubular cross section and a hollow.

25. A heat exchanger assembly as in claim 24, further comprising a slit in the tubular cross section.

26. A heat exchanger assembly as in claim 25, further comprising a rib on the tubular cross section.

27. A heat exchanger assembly, as in claim 26, wherein the wiper rib is a non-perpendicular wiper rib.

28. A heat exchanger assembly as in claim 24, having at least two isolators.

29. A heat exchanger assembly as in claim 26, having at least two isolators mounts.

30. A vehicle or mobile system multi-portion isolator having walls and a hollow area, wherein at least one portion is located around the hollow area to form a tubular hollow portion.

31. A multi-portion isolator as in claim 30, wherein the walls consist of connecting walls and tubular portion walls and wherein the walls surrounding the hollow area of the tubular portion (tubular walls) are approximately one-half (½) times the thickness of the normal thickness connecting walls.

32. An isolator as in claim 31, wherein the tubular portion deflects upon application of light load.

33. An isolator as in claim 32, wherein the hollow portion is closed when the tubular portion is deflected.

34. An isolator as in claim 33, wherein the walls close the hollow portion and have a surrounding wall thickness approximately doubled versus the free state position when heavy load is applied.

35. An isolator as in claim 34, wherein the tubular walls under load have a uniform thickness in their compressed state of approximately equal to the normal wall thickness of the rest of the isolator when heavy load is applied.

36. An isolator as in claim 32, having at least two portions.

37. An isolator as in claim 36, wherein the tubular wall cross section around at least one of the hollow portions forms a shape similar to an ellipse.

38. An isolator, as in claim 36, wherein the tubular wall cross section around at least one of the hollow portions forms a shape similar to an eyelet.

39. An isolator, as in claim 37, wherein at least one portion is a normal elliptical portion with a narrow end slit portion at the end of the major axis of the elliptical portion of the hollow area, and wherein (x) is equal to or less that one-quarter (¼) the height (h) of the inside hollow area.

40. An isolator, as in claim 36, wherein the tubular wall cross section around at least one of the hollow portions forms a shape similar to a round cross section.

41. An isolator as in claim 36, wherein the tubular wall cross section around at least one of the hollow portions forms a shape similar to a polygon.

42. An isolator as in claim 41, wherein the tubular wall has portions flatted and at an angle to an adjacent wall portion.

43. As isolator as in claim 36, having at least one rib on the tubular wall.

44. As isolator as in claim 43, having an adjacent wall having at least two non-perpendicular sections joined by a knee portion at the midpoint and being of a thickness such that the wall is approximately less than one-half (½) times the height of the remaining hollow port opening.

45. As isolator, as in claim 44, wherein the rib length is less than two (2) times the tubular hollow port width such that when the isolator is deflected inward from two (2) opposing contact surfaces to close the hollow portion the walls approximately fill the hollow area to become a uniform thickness approximately equal to the remainder of normal wall.

46. An isolator, is in claim 45, wherein the at least one tubular hollow portion has an internal adjacent wall having a curved shape and is of a thickness such that the wall is approximately less than one-half (½) times the height of the remaining hollow port opening.

47. An isolator, as in claim 46, wherein the wall length is less than or equal to two (2) times the port width such that when the isolator is deflected inward from two (2) opposing contact surfaces to close the hollow portion the walls approximately fill the hollow area to become a uniform thickness approximately equal to the remainder of normal wall.

48. An isolator as in claim 36, such that at least one wall around the hollow wall is not perpendicular to the contact surface and apposing the inertia load at the base next to the normal uniform wall thickness.

49. An isolator as in claim 36, wherein at least one wall has at least one wiper rib that when deflected to flat forms an approximately uniform wall thickness with the remainder of the normal isolator wall.

50. An isolator, as in claim 36, wherein the isolator material is made of an elastic compound with an average durometer rating of between 30 and 90 durometers.
